(19) United States
(12) Patent Application Publication
(10) Pub. No.: US 2013/0195679 A1
(43) Pub. Date: Aug. 1, 2013

(54) ION PUMP SYSTEM

(71) Applicant: Shukichi Tanaka, Koganei-shi (JP)

(72) Inventor: Shukichi Tanaka, Koganei-shi (JP)

(73) Assignee: National Institute of Information and Communicatio, Koganei-shi, Tokyo (JP)

(21) Appl. No.: 13/638,615

(22) PCT Filed: Apr. 2, 2010
(86) PCT No.: PCT/JP2010/002430

§ 371 Date: Oct. 16, 2012

(51) Int. Cl. H01J 41/12

(52) U.S. Cl. CPC H01J 41/12
USPC 417/48

(57) ABSTRACT

Disclosed is an ion pump system capable of efficaciously utilizing electrical fields and magnetic fields in all portions of a getter face, and thus of substantially improving exhaust efficiency. In particular, the present disclosure is based on the discovery that disposing a plurality of disc-shaped electrodes upon an internal casing (12) and further disposing a plurality of disc-shaped electrodes also upon an external casing (11) eliminates saddle points, allowing efficacious utilization of electrical fields and magnetic fields in all portions of the getter face, and thus substantially improving exhaust efficiency.

### TECHNICAL FIELD

The present invention relates to an ion pump system having a plurality of disc-shaped electrodes. The present invention relates to an ion pump system capable of effectively using electric fields and magnetic fields in all portions of a getter surface, and thus of distinctly improving exhaust efficiency.

### BACKGROUND ART

WO 2009/101814 (Patent Literature 1 below) proposes an ion pump system having a plurality of electrode layers. FIGS. 18, 20, and 21 in WO 2009/101814 disclose an ion pump system having a magnet provided in an inner casing and a magnet provided in an outer casing.

Patent Literature 1: WO 2009/101814

### SUMMARY OF INVENTION

### Technical Problem

The ion pump system disclosed in WO 2009/101814 has high exhaust efficiency when compared with conventional ion pumps. Unfortunately, however, a saddle point as a portion where no effective magnetic field is present is inevitably present even if an electric field and a getter surface are present inside a casing.

For example, no effective magnetic flux is present in a portion where an electrode is provided in a conventional ion pump system, creating a saddle point.

Thus, an object of the present invention is to provide an ion pump system capable of effectively using electric fields and magnetic fields in all portions of a getter surface, and thus of distinctly improving exhaust efficiency.

### Solution to Problem

The present invention is based on the finding that saddle points can be eliminated and electric fields and magnetic fields in all portions of a getter surface can effectively be used by basically providing a plurality of disc-shaped electrodes from an inner casing and further a plurality of disc-shaped electrodes from an outer casing, and thus of distinctly improving exhaust efficiency.

A first aspect of the present invention is relates to an ion pump system including an outer casing 11 and an inner casing 12 provided inside the outer casing 11. The outer casing 11 includes a plurality of outer circumferential electrodes 21. The plurality of outer circumferential electrodes 21 is disc-shaped electrodes mounted on the outer casing 11 toward the inner casing 12 at predetermined intervals. On the other hand, the inner casing 12 includes a plurality of inner circumferential electrodes 22. The plurality of inner circumferential electrodes 22 is disc-shaped electrodes mounted on the inner casing 12 toward the outer casing 11 at predetermined intervals. The plurality of outer circumferential electrodes 21 and the plurality of inner circumferential electrodes 22 are parallel to each other. A portion 23 (inner circumferential portion of the outer circumferential electrode) closest to the inner casing 12 of the plurality of outer circumferential electrodes 21 is positioned closer to the inner casing 12 than to a portion 24 (outer circumferential portion of the inner circumferential electrode) closest to the outer casing 11 of the plurality of inner circumferential electrodes 22.

Because the configuration described above is provided, a magnetic flux is generated between the outer circumferential electrode 21 and the inner circumferential electrode 22. Moreover, a magnetic flux is generated in all places of the outer casing 11 and the inner casing 12. Therefore, according to the present invention, electric fields and magnetic fields can effectively be used in all portions of a getter surface, thereby distinctly improving exhaust efficiency.

A preferred embodiment of the present invention further includes an inner magnet 31. The inner magnet 31 is provided in a space 32 of the inner casing 12 on the side opposite to the outer casing 11 to provide a magnetic field to the space between the outer casing 11 and the inner casing 12.

An ion pump system with the inner magnet 31 can reduce leakage of the magnetic flux out of the system.

A preferred embodiment of the present invention further includes an outer magnet 33. The outer magnet 33 is provided in the outer casing 11 to provide a magnetic field to the space between the outer casing 11 and the inner casing 12.

A preferred embodiment of the present invention includes the inner casing 12 having a mesh portion, thereby enabling a gas present on the inner or outer of the inner casing 12 to move through the mesh portion.

### ADVANTAGEOUS EFFECTS OF INVENTION

According to the present invention, a plurality of disc-shaped electrodes is provided from an inner casing and further a plurality of disc-shaped electrodes is provided from an outer casing. Saddle points can thereby be eliminated so that electric fields and magnetic fields can effectively be used in all portions of a getter surface and exhaust efficiency can distinctly be improved.

### BRIEF DESCRIPTION OF DRAWINGS

FIG. 1 is a schematic diagram illustrating an ion pump system according to the present invention.

FIG. 2 is a diagram illustrating a state of electric fluxes and magnetic fluxes of the ion pump system in FIG. 1.

FIG. 3 is a reference diagram illustrating a case when neither outer circumferential electrode nor inner circumferential electrode is present in FIG. 1.

FIG. 4 is a schematic diagram illustrating the ion pump system having an inner magnet as a magnetic flux source.

FIG. 5 is a schematic diagram illustrating the ion pump system having an outer magnet as a magnetic flux source.

FIG. 6 is a schematic diagram illustrating the ion pump system in which an inner casing is configured by a mesh.

FIG. 7 is a schematic diagram illustrating the ion pump system in which the outer magnet is present not only on the side face, but also on the bottom surface and the top surface.

### DESCRIPTION OF EMBODIMENTS

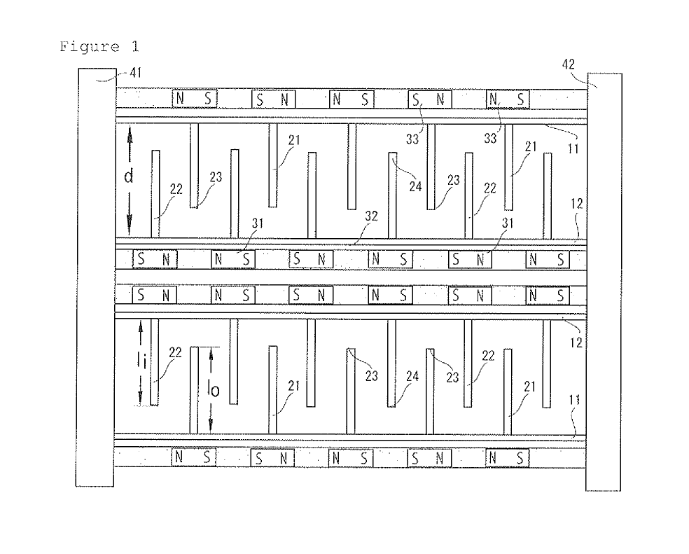

FIG. 1 is a schematic diagram illustrating an ion pump system according to the present invention. As illustrated in FIG. 1, the ion pump system according to the present invention includes an outer casing 11 and an inner casing 12 provided inside the outer casing 11. The outer casing 11 includes a plurality of outer circumferential electrodes 21. The plurality of outer circumferential electrodes 21 is disc-shaped electrodes mounted on the outer casing 11 toward the inner casing 12 at predetermined intervals. On the other hand, the inner casing 12 includes a plurality of inner circumferential electrodes 22. The plurality of inner circumferential electrodes 22 is disc-shaped electrodes mounted on the inner casing 12 toward the outer casing 11 at predetermined intervals. The plurality of outer circumferential electrodes 21 and the plurality of inner circumferential electrodes 22 are parallel to each other. A portion 23 (inner circumferential portion of the outer circumferential electrode) closest to the inner casing 12 of portions of the outer circumferential electrode 21 is positioned closer to the inner casing 12 than to a portion 24 (outer circumferential portion of the inner circumferential electrode) closest to the outer casing 11 of the plurality of inner circumferential electrodes 22. The example illustrated in FIG. 1 further includes an inner magnet 31. The inner magnet 31 is provided in a space 32 of the inner casing 12 on the side opposite to the outer casing 11 to provide a magnetic field to the space between the outer casing 11 and the inner casing 12. The example illustrated in FIG. 1 further includes an outer magnet 33. The outer magnet 33 is provided in the outer casing 11 to provide a magnetic field to the space between the outer casing 11 and the inner casing 12. In FIG. 1, reference numeral 41 and reference numeral 42 mean flanges for connection. Each element will be described below. The known configuration of an ion pump system can be adopted when appropriate for the configuration of elements other than elements that will be described below.

The outer casing 11 is a framework of an ion pump system. A cylindrical shape can be cited as the shape of the outer casing 11. Various electrodes may be formed inside the framework. Wires to drive electrodes are provided and such a wire that can receive a drive signal from a drive signal source and propagate the drive signal to an inner electrode is preferable. Further, the outer casing 11 may function as an electrode. Incidentally, an element covering the outer casing 11 may be present outside the outer casing 11. The outer magnet 33 is normally provided inside the outer casing 11. However, as illustrated in FIG. 1, the outer magnet 33 may be provided on the outer of the outer casing 11. Publicly known materials such as aluminum, titanium, and stainless can be cited as the material of the outer casing 11. Among these materials, aluminum having titanium deposited on the surface thereof is preferable because the inner wall itself of the outer casing 11 can be used as an electrode. In this manner, the ion pump system can be made lighter and also the structure thereof can be made simpler and smaller.

The inner casing 12 is a casing provided inside the outer casing 11. An example of the inner casing is an inner casing disclosed in FIGS. 16 and 20 of WO 2009/101814. The inner casing 12 preferably has a property to allow a magnetic flux to pass through to some extent.

The outer circumferential electrodes 21 are disc-shaped electrodes mounted on the outer casing 11 toward the inner casing 12 at predetermined intervals. The interval at which the outer circumferential electrodes 21 are installed is preferably fixed. That is, the outer circumferential electrodes 21 are preferably provided at equal intervals on the outer casing 11. The interval may appropriately be adjusted in accordance with the size of an ion pump and the voltage applied to an electrode.

The outer circumferential electrode 21 is a disc-shaped electrode. The outer circumference of the outer circumferential electrode 21 is mounted on the outer casing 11. On the other hand, the outer circumferential electrode 21 has a circular notch portion near the center thereof. Thus, the outer circumferential electrode 21 is not in contact with the inner casing 12. The distance between the inner casing 12 and the outer casing 11 is set as d. Then, the length of the outer circumferential electrode 21 is set as lₒ. lₒ is considered to be the distance from the outer casing 11 to the portion 23 (inner circumferential portion of the outer circumferential electrode) closest to the inner casing 12 of the outer circumferential electrode 21. In this case, lₒ can be cited as being 0.55 d or more and 0.95 d or less and may he 0.6 d or more and 0.9 d or less, 0.7 d or more and 0.9 d or less, or 0.7 d or more and 0.85 d or less. That is, if lₒ is small, sufficient electric fluxes are not generated between the outer circumferential electrode 21 and the inner circumferential electrode 22. On the other hand, if lₒ is large, it becomes more difficult for a gas to move inside the casing, leading to lower exhaust efficiency. Any publicly known material having a conductive portion may be used as the material of the outer circumferential electrode.

The inner circumferential electrodes 22 are disc-shaped electrodes mounted on the inner casing 12 toward the outer casing 11 at predetermined intervals. The interval at which the inner circumferential electrodes 22 are installed is preferably fixed. That is, the inner circumferential electrodes 22 are preferably provided at equal intervals on the inner casing 12. The interval is preferably the same as the interval of the outer circumferential electrodes 21 and may appropriately be adjusted in accordance with the size of an ion pump and the voltage applied to an electrode.

The inner circumferential electrode 22 is a disc-shaped electrode. The inner circumference of the inner circumferential electrode 22 is mounted on the inner casing 12. The inner circumferential electrode 22 is not in contact with the outer casing 11. Then, the length of the inner circumferential electrode 22 is set as lᵢ. lᵢ is considered to be the distance from the inner casing 12 to the portion 24 (outer/inner circumferential portion of the inner circumferential electrode) closest to the outer casing 11 of the inner circumferential electrode 22. In this case, lᵢ can be cited as being 0.55 d or more and 0.95 d or less and may be 0.6 d or more and 0.9 d or less, 0.7 d or more and 0.9 d or less, or 0.7 d or more and 0 85 d or less. That is, if lᵢ is small, sufficient electric fluxes are not generated between the inner circumferential electrode 22 and the inner circumferential electrode 22. On the other hand, if lᵢ is large, it becomes more difficult for a gas to move inside the casing, leading to lower exhaust efficiency. Any publicly known material having a conductive portion may be used as the material of the outer circumferential electrode.

One of the outer circumferential electrode 21 and the inner circumferential electrode 22 is a positive electrode and the other is a negative electrode. In the present invention, the polarity of the negative electrode and the positive electrode is preferably changeable. Such a change of the polarity can easily be achieved by changing the drive voltage of a drive unit.

The outer circumferential electrode 21 and the inner circumferential electrode 22 have a disc-shaped shape. On the other hand, these electrodes may have a plurality of holes in a disc-shaped shape. Because of the plurality of holes of the disc, a gas flows effectively inside the casing. The size of each hole can be cited as being 0.01 d or more and 0.3 d or less and may be 0.05 d or more and 0.2 d or less. Holes are preferably provided symmetrically. The number of holes of each disc is preferably between 2 and 100.

As illustrated in FIG. 1, the outer circumferential electrode 21 and the inner circumferential electrode 22 are preferably installed in parallel with each other. Moreover, as illustrated in FIG. 1, the outer circumferential electrode 21 and the inner circumferential electrode 22 are preferably present alternately at equal intervals.

The example illustrated in FIG. 1 further includes the inner magnet 31. The inner magnet 31 is provided in the space 32 of the inner casing 12 on the side opposite to the outer casing 11 to provide a magnetic field to the space between the outer casing 11 and the inner casing 12. A publicly known magnet used for an ion pump can appropriately be used. More specifically, the magnet may be a magnetic coil or a permanent magnet. The inner magnet 31 includes a plurality of cylindrical permanent magnets spaced in a direction parallel to the center axis of the inner casing (longitudinal direction of the center axis). That is, as illustrated in FIG. 1, the inner magnet 31 in this mode is formed by aligning a plurality of ring-shaped permanent magnets. An ion pump system in this mode has a plurality of divided cylindrical magnets installed with a predetermined space therebetween instead of using one cylindrical magnet and therefore, the ion pump system can be made lighter and also an efficient magnetic field can be generated. Moreover, by adopting such a configuration, the structure of arranging a magnetic field generated by an interference effect between a group of magnets of a pump portion on the inner and a group of magnets of the ion pump on the outer can be optimized to realize a more efficient exhaust operation. The example illustrated in FIG. 1 has a magnetic field rectifier between the inner magnets 31.

The example illustrated in FIG. 1 further includes the outer magnet 33. The outer magnet 33 is provided in the outer casing 11 to provide a magnetic field to the space between the outer casing 11 and the inner casing 12. A magnet like the inner. magnet 31 can be used as the outer magnet 33. However, the outer magnet 33 preferably has a smaller magnetic force than the inner magnet 31. A magnetic flux originating from the inner magnet 31 is normally not leaked out of the outer casing 11. Thus, a relatively strong magnet can be adopted for the inner magnet 31. On the other hand, if the magnetic force of the outer magnet 33 is strong, it becomes necessary to cover the outer magnet 33 with a magnetic shield so that a magnetic flux of the outer magnet 33 should not be leaked. Therefore, the outer magnet 33 preferably has a weaker magnetic force than the inner magnet 31. The magnetic force of the outer magnet 33 can be cited as being, for example, 0.1 time or more and 1 time or less the magnetic force of the inner magnet 31 and may be 0.5 times or more and 0.9 times. Naturally, the outer magnet 33 and the inner magnet 31 have comparable magnetic forces.

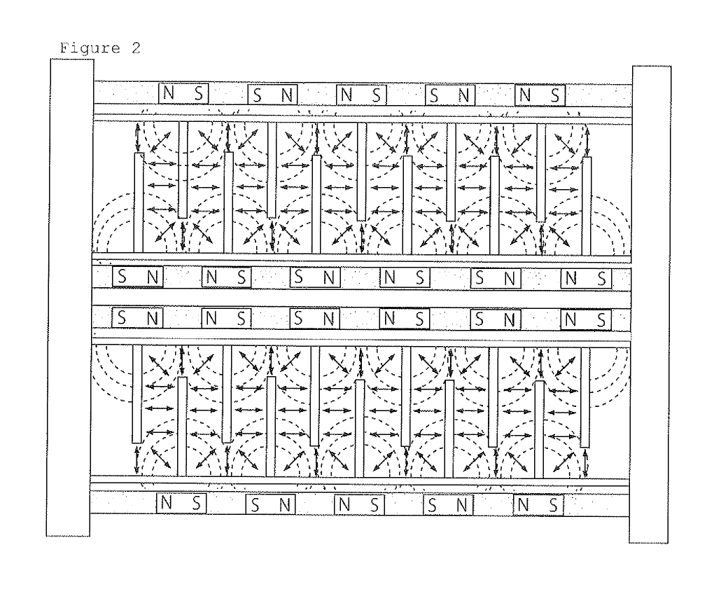

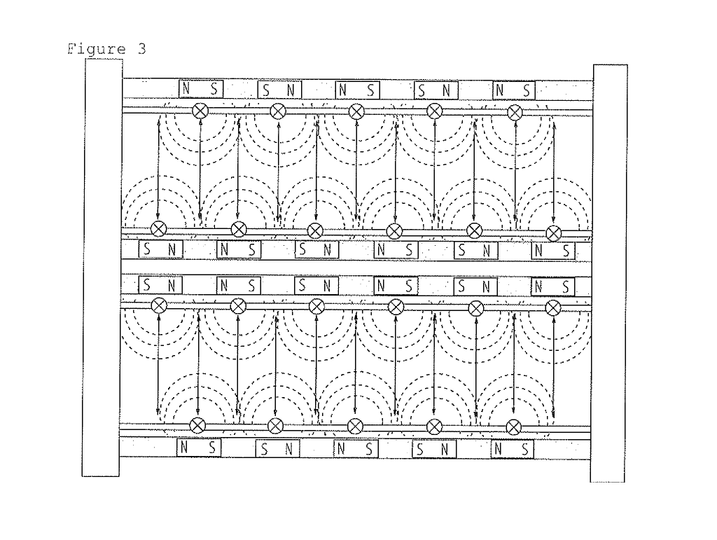

FIG. 2 is a diagram illustrating a state of electric fluxes and magnetic fluxes of the ion pump system in FIG. 1. FIG. 3 is a reference diagram illustrating a case when neither outer circumferential electrode 21 nor inner circumferential electrode 22 is present in FIG. 1.

If, as illustrated in FIG. 3, neither the outer circumferential electrode 21 nor the inner circumferential electrode 22 is present, a portion where an effective magnetic flux is not present arises. In this example, the outer casing 11 and the inner casing 12 function as electrodes. Then, in this example, an electric flux is generated between the outer casing 11 and the inner casing 12. Because the outer casing 11 and the inner casing 12 are relatively far apart, the strength of the electric flux is relatively weak. As a result, the exhaust efficiency of the ion pump system illustrated in FIG. 3 decreases.

In the example illustrated in FIG. 2, on the other hand, a magnetic flux is generated also in a portion where no effective magnetic flux is present in FIG. 3. Accordingly, the effective area of electrodes involved in evacuation maintenance can be increased twofold to threefold.

An ion pump system according to the present invention can be operated in the same manner as a publicly known ion pump. The principle of operation of an ion pump is publicly known. The principle of operation of an ion pump will briefly be described below. A voltage of a few kV is applied between the negative electrode and positive electrode of the ion pump. Then, primary electrons are emitted from the negative electrode. Primary electrons emitted from the negative electrode are affected by a magnetic field provided by a permanent magnet while being attracted to the positive electrode. Thus, primary electrons reach the positive electrode by whirling round in a long spiral motion. On the way to the positive electrode, primary electrons collide against neutral gas molecules to generate many positive ions and secondary electrons. Generated secondary electrons further make a spiral motion and collide against other gas molecules to generate positive ions and electrons. Each ion is adsorbed by the electrode. Thus, also in the present invention, primary electrons are emitted from the negative electrode when a potential difference is generated between the outer circumferential electrode 21 and the inner circumferential electrode 22 and a gas is adsorbed by the electrode according to the above principle.

In addition to the above configuration, the ion pump system according to the present invention can adopt publicly known configurations used for an ion pump if appropriate. For example, a heating unit or cooling unit may be installed if appropriate. Collection efficiency of gas can be improved by cooling the system using the cooling unit. On the other hand, a gas captured by each electrode can be emitted by maintaining a vacuum through heating of the electrode by using the heating unit.

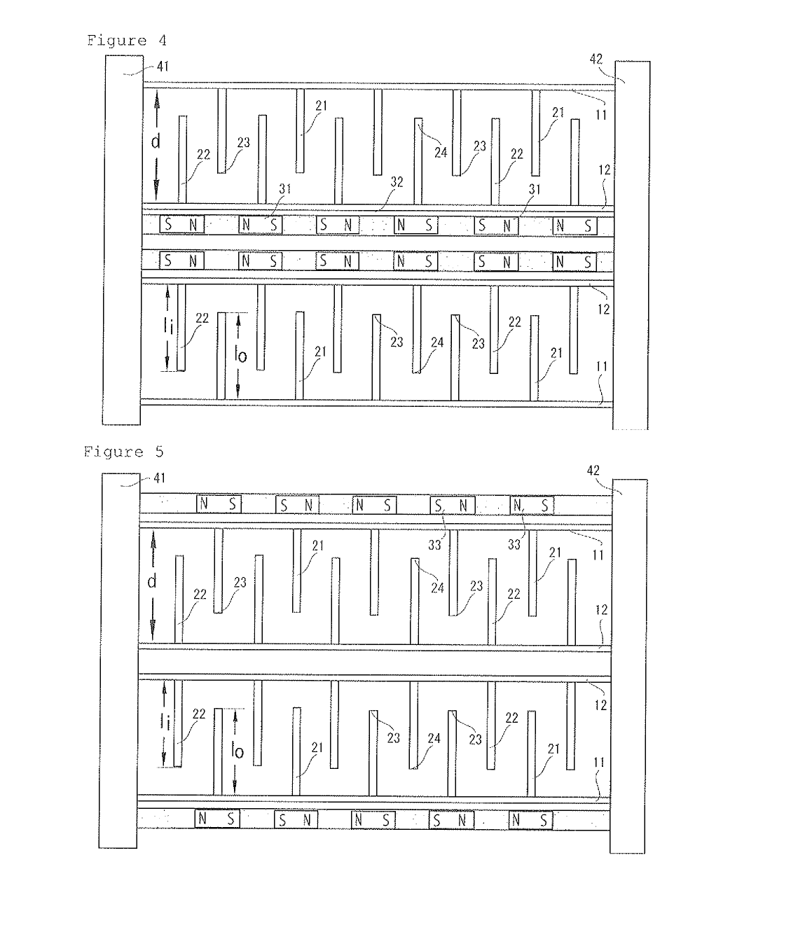

Next, an ion pump system according to the present invention in a different embodiment from the above embodiment will be described. FIG. 4 is a schematic diagram illustrating the ion pump system having an inner magnet as a magnetic flux source. This is a mode in which the inner magnet 31 is included in the casing as a magnetic flux source to provide a magnetic flux. The inner magnet 31 is provided in the space 32 of the inner casing 12 on the side opposite to the outer casing 11 to provide a magnetic field to the space between the outer casing 11 and the inner casing 12. No outer magnet is present in the example illustrated in FIG. 4. Because no outer magnet is present in the ion pump system in this mode, circumstances in which a magnetic flux is leaked out of the ion pump system can be reduced.

In the ion pump system in this mode, the length of the inner circumferential electrode 22 and the length lᵢ of the outer circumferential electrode 21 may be the same. On the other hand, an electric flux near the outer casing 11 may be weakened in the ion pump system in this mode. Thus, in the ion pump system in this mode, it is preferable to make the length lᵢ. of the inner circumferential electrode 22 longer than the length l, of the outer circumferential electrode 21. The length of the inner circumferential electrode 22 can be cited as being 1.05 times or more and 1.5 times or less the length l, of the outer circumferential electrode 21 and may be 1.1 times or more and 1.3 times or less.

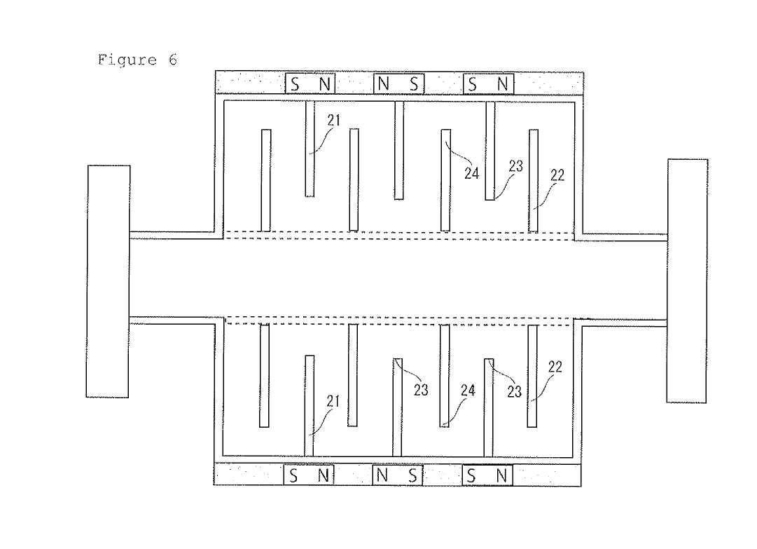

Next, an ion pump system according to the present invention in a different embodiment from the above embodiments will be described. FIG. 5 is a schematic diagram illustrating the ion pump system having an outer magnet as a magnetic flux source. No inner magnet is present in the example illustrated in FIG. 5. Because no inner magnet is present in the ion pump system in this mode, the diameter of the inner casing 12 can be made smaller so that the electrode area can be increased.

In the ion pump system in this mode, the length lᵢ of the inner circumferential electrode 22 and the length lₒ of the outer circumferential electrode 21 may be the same. On the other hand, an electric flux near the inner casing 12 may be weakened in the ion pump system in this mode. Thus, in the ion pump system in this mode, it is preferable to make the length lₒ of the outer circumferential electrode 21 longer than the length lᵢ of the inner circumferential electrode 22. The length lₒ of the outer circumferential electrode 21 can be cited as being 1.05 times or more and 1.5 times or less the length of the inner circumferential electrode 22 and may be 1.1 times or more and 1.3 times or less. In the mode illustrated in FIG. 5, the inner casing 12 may have a rod shape, instead of a cylindrical shape.

FIG. 6 is a schematic diagram illustrating the ion pump system in which an inner casing is configured by a mesh. The ion pump system can adopt every element described above except that the inner casing 12 has a mesh portion. Because the inner casing 12 has a mesh portion in the ion pump system, a gas present on the inner or outer of the inner casing 12 can move through the mesh portion. An example of the mesh portion is the whole region where inner circumferential electrodes and outer circumferential electrodes are present. A mesh is a network structure having a plurality of regular holes. The size of a hole of the mesh may appropriately be adjusted.

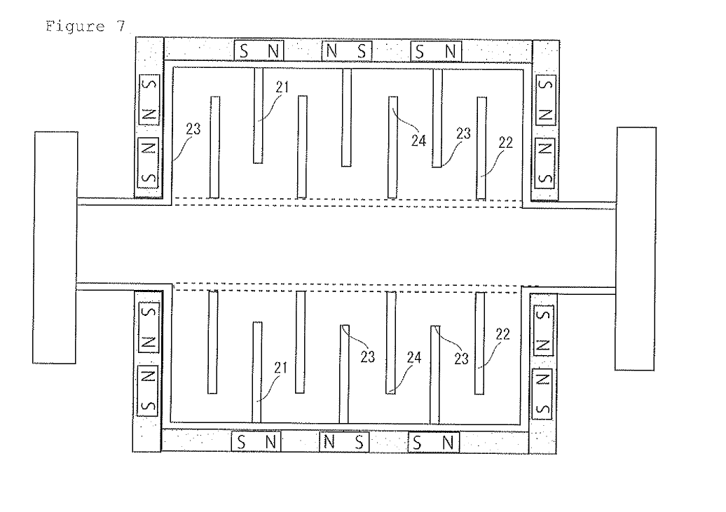

FIG. 7 is a schematic diagram illustrating the ion pump system in which the outer magnet is present not only on the side face, but also on the bottom surface and the top surface. FIG. 1, the outer magnet 33 is present on the side face of the outer casing in a cylindrical shape. An example of the outer magnet 33 is a magnet in a cylindrical shape surrounding the outer casing. In the example illustrated in FIG. 7, the outer magnet is present not only on the side face, but also on the bottom surface and the top surface An example of the outer magnets present on the bottom surface and the top surface is an outer magnet disposed concentrically with the inner casing 12 and the outer casing 11. In the example illustrated in FIG. 7, the outer magnets present on the bottom surface and the top surface are each present in a double-circle shape. Thus, with the outer magnets also present on the bottom surface and the top surface, the magnetic force inside the outer casing can be made stronger.

### INDUSTRIAL APPLICABILITY

An ion pump system according to the present invention can suitably be utilized in a vacuum equipment industry and the field of material activation. An electromagnetic field generator according to the present invention can suitably be utilized in the field of material activation.

### REFERENCE SIGNS LIST

11 Outer casing
12 Inner casing
21 Outer circumferential electrode
22 Inner circumferential electrode
23 Inner circumferential portion of the outer circumferential electrode
24 Outer/inner circumferential portion of the inner circumferential electrode
31 Inner magnet
32 Internal space of the inner casing
33 Outer magnet

1. An ion pump system having an outer casing (11) and an inner casing (12) provided inside the outer casing (11), wherein
the outer casing (11) includes a plurality of outer circumferential electrodes (21) and the plurality of outer circumferential electrodes (21) is disc-shaped electrodes mounted on the outer casing (11) toward the inner casing (12) at predetermined intervals,
the inner casing (12) includes a plurality of inner circumferential electrodes (22) and the plurality of inner circumferential electrodes (22) is disc-shaped electrodes mounted on the inner casing (12) toward the outer casing (11) at predetermined intervals,
the plurality of outer circumferential electrodes (21) and the plurality of inner circumferential electrodes (22) are parallel to each other, and
a portion (23) closest to the inner casing (12) of the plurality of outer circumferential electrodes (21) is positioned closer to the inner casing (12) than a portion (24) closest to the outer casing (11) of the plurality of inner circumferential electrodes (22).

2. The ion pump system according to claim 1, further comprising:
an inner magnet (31), wherein
the inner magnet (31) is provided in a space (32) of the inner casing (12) on a side opposite to the outer casing (11) to provide a magnetic field to a space between the outer casing (11) and the inner casing (12).

3. The ion pump system according to claim 1 or 2, further comprising:
an outer magnet (33), wherein
the outer magnet (33) is provided in the outer casting (11) to provide the magnetic field to the space between the outer casing (11) and the inner casing (12).

4. The ion pump system according to claim 1, wherein
the inner casing (12) includes a mesh portion and a gas present on an inner side or an outer side of the inner casing (12) can thereby move through the mesh portion.
